(19) United States
(12) Patent Application Publication
(10) Pub. No.: US 2026/0066521 A1
(43) Pub. Date: Mar. 5, 2026

(54) ANTENNA STRUCTURE

(71) Applicant: HL KLEMOVE CORPORATION, Incheon (KR)

(72) Inventors: HYUNSEOK LEE, Incheon (KR); SUNGJOON HEO, Incheon (KR)

(21) Appl. No.: 18/966,521

(22) Filed: Dec. 3, 2024

(30) Foreign Application Priority Data
Sep. 5, 2024 (KR) 10-2024-0120829

(51) Int. Cl. H01Q 1/22; H01Q 13/10

(52) U.S. Cl. CPC H01Q 1/22; H01Q 13/10

(57) ABSTRACT

An antenna structure is disclosed. An antenna structure according to an aspect of the present disclosure comprises a printed circuit board having a feeding part that transmits a radio frequency (RF) signal on one surface of the printed circuit board; and an antenna module coupled to the printed circuit board so that one surface of the antenna module faces the one surface of the printed circuit board, and having the other surface on which a plurality of antenna slots for emitting the RF signal received from the feeding part are formed, wherein the antenna module is coupled to the printed circuit board in a snap-fit manner.

### CROSS-REFERENCE TO RELATED APPLICATION

This application claims priority to and the benefit of Korean Patent Application No.10-2024-0120829, filed on September 5, 2024, the disclosure of which is incorporated herein by reference in its entirety.

### BACKGROUND

### Technical Field

The present disclosure relates to an antenna structure.

### Description of Related Art

Recently, WGIM (Wave Guided Injection Molded) antennas are being applied to vehicle radars. WGIM (Wave Guided Injection Molded) antennas have the advantage of having a higher gain than micro-strip antennas and less change in antenna performance due to manufacturing.

In the conventional WGIM (Wave Guided Injection Molded) antenna, a printed circuit board and an antenna module are separately manufactured and combined by bolts or rivets. Therefore, it is essential that a bolt hole or rivet hole is formed in the printed circuit board and antenna module.

Therefore, a separate process of forming a bolt hole or rivet hole in the printed circuit board and the antenna module is required to combine the printed circuit board and the antenna module.

In addition, bolt holes or rivet holes become constraints when designing the arrangement of elements or feeding lines for printed circuit boards, resulting in poor design freedom or arrangement freedom of printed circuit boards.

### BRIEF SUMMARY

The present disclosure is directed to providing an antenna structure configured to allow simple assembly without a separate process of forming a coupling hole when a printed circuit board and an antenna module are combined.

The present disclosure is also directed to providing an antenna structure configured to improve the degree of freedom of arrangement of elements or feeding lines on a printed circuit board.

The objects of the present disclosure are not limited to the above-described objects, and other objects that are not mentioned will be able to be clearly understood by those skilled in the art to which the present disclosure pertains from the following description.

According to an aspect of the present disclosure, provided is an antenna structure including a printed circuit board having a feeding part that transmits a radio frequency (RF) signal on one surface of the printed circuit board; and an antenna module coupled to the printed circuit board so that one surface of the antenna module faces the one surface of the printed circuit board, and having the other surface on which a plurality of antenna slots for emitting the RF signal received from the feeding part are formed, wherein the antenna module is coupled to the printed circuit board in a snap-fit manner.

At this time, the antenna module may include an antenna body having one surface facing one surface of the printed circuit board and the other surface on which the antenna slots are formed; and a snap-fit coupling part extending from the antenna body toward the printed circuit board and coupled to the printed circuit board.

At this time, the snap-fit coupling part may be disposed in an edge region of the antenna body.

Meanwhile, the snap-fit coupling part may be formed to extend from one surface of the antenna body facing the printed circuit board.

Meanwhile, the snap-fit coupling part may be formed to extend from an outermost side surface of the antenna body.

Meanwhile, the antenna body and the snap-fit coupling part may be integrally manufactured by injection molding.

Meanwhile, the snap-fit coupling part may be provided in plurality.

Meanwhile, a coupling hole penetrating between one surface and the other surface of the printed circuit board and into which a distal end of the snap-fit coupling part is inserted may be formed in the printed circuit board, and the distal end of the snap-fit coupling part may be formed to be inserted into the coupling hole and to be caught on a part of the printed circuit board.

Meanwhile, the coupling hole may be formed in an edge region of the printed circuit board.

Meanwhile, a distal end of the snap-fit coupling part may be formed to be caught on a part of the printed circuit board while surrounding an outermost side surface of the printed circuit board.

Meanwhile, a distal end of the snap-fit coupling part may be formed to be caught on the other surface of the printed circuit board.

Meanwhile, a coupling hole penetrating between one surface and the other surface of the printed circuit board and into which a distal end of the snap-fit coupling part is inserted may be formed in the printed circuit board, and the distal end of the snap-fit coupling part may be formed to be caught on a stepped portion formed inside the coupling hole.

Meanwhile, a distal end of the snap-fit coupling part may be formed to be caught on a stepped portion formed on an outermost side surface of the printed circuit board.

Meanwhile, a distal end of the snap-fit coupling part may be positioned on the same plane as the other surface of the printed circuit board.

Meanwhile, the snap-fit coupling part may include an extension body extending from the antenna body; and a hook formed to protrude from a distal end of the extension body and caught on a part of the printed circuit board.

Meanwhile, the antenna structure may further include a spacer interposed between the printed circuit board and the antenna module so that the printed circuit board and the antenna module are spaced apart at a predetermined interval.

At this time, the spacer may be disposed at a position corresponding to the feeding part, and a waveguide connecting the feeding part and the antenna module may be formed in the spacer.

At this time, the spacer may be disposed at a central region of the printed circuit board.

Meanwhile, the spacer may be disposed to be biased in any one direction in the central region of the printed circuit board, the snap-fit coupling part may be provided in plurality, and the plurality of snap-fit coupling parts may be disposed such that external force acting on the antenna structure is uniformly distributed.

Meanwhile, according to another aspect of the present disclosure, provided is an antenna structure, including a printed circuit board; and an antenna module coupled to the printed circuit board, wherein the antenna module includes an antenna body having one surface facing one surface of the printed circuit board and the other surface on which an antenna slot is formed; and a plurality of snap-fit coupling parts extending from the antenna body toward the printed circuit board and coupled to the printed circuit board.

### BRIEF DESCRIPTION OF THE SEVERAL VIEWS OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of an antenna structure according to an exemplary embodiment of the present disclosure;

FIG. 2 is an exploded perspective view of an antenna structure according to an exemplary embodiment of the present disclosure;

FIG. 3 is a side view of an antenna structure according to an exemplary embodiment of the present disclosure;

FIG. 4 is a view illustrating an upper surface of a printed circuit board constituting an antenna structure according to an exemplary embodiment of the present disclosure;

FIG. 5 is an enlarged cross-sectional view of part A of FIG. 1 viewed from one direction;

FIG. 6 is a modified example of a formation position of a snap-fit coupling part shown in FIG. 1;

FIG. 7 is a modified example of a coupling position of a distal end of the snap-fit coupling part shown in FIG. 6;

FIG. 8 is a view illustrating a modified example of a position where the snap-fit coupling part shown in FIG. 7 is caught;

FIG. 9 is a view illustrating another modified example of a position where the snap-fit coupling part shown in FIG. 7 is caught;

FIGS. 10 to 12 are views illustrating modified examples of the number and arrangement of snap-fit coupling parts according to an exemplary embodiment of the present disclosure; and

FIG. 13 is a view illustrating a modified example of a position of a spacer according to an exemplary embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have”are intended to specify the presence of features, numbers, steps, operations, components, parts, or combinations thereof described in the specification and do not preclude the possibility of the presence or addition of one or more other features, numbers, steps, operations, components, parts, or combinations thereof.

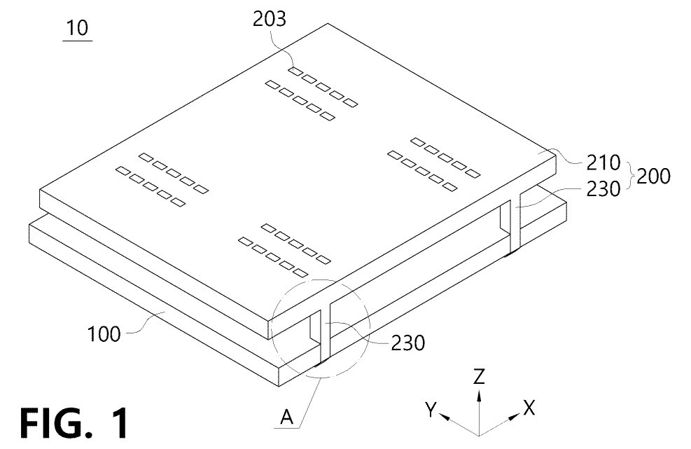

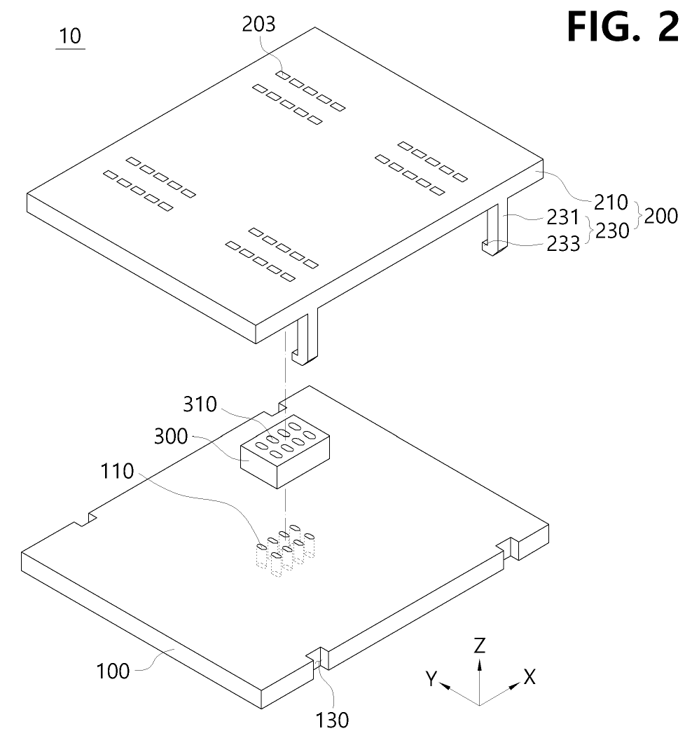

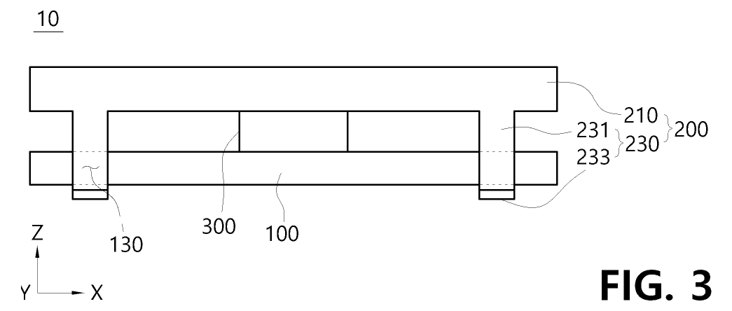

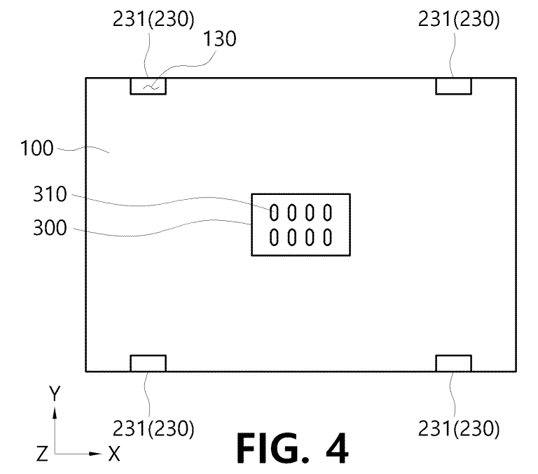

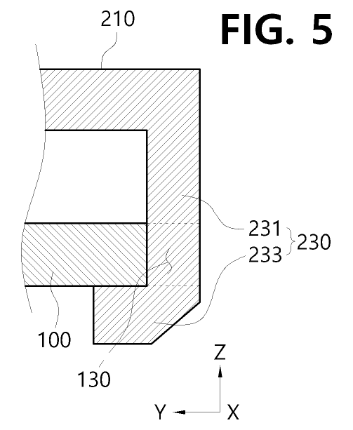

FIG. 1 is a perspective view of an antenna structure according to an exemplary embodiment of the present disclosure, FIG. 2 is an exploded perspective view of an antenna structure according to an exemplary embodiment of the present disclosure, FIG. 3 is a side view of an antenna structure according to an exemplary embodiment of the present disclosure, FIG. 4 is a view illustrating an upper surface of a printed circuit board constituting an antenna structure according to an exemplary embodiment of the present disclosure, and FIG. 5 is an enlarged cross-sectional view of part A of FIG. 1 viewed from one direction. For reference, in FIGS. 1 to 5, the +Z-axis direction is defined upward direction of the antenna structure.

Referring to FIGS. 1 to 5, an antenna structure 10 according to an exemplary embodiment of the present disclosure includes a printed circuit board 100 and an antenna module 200, and the antenna module 200 is coupled to the printed circuit board 100 in a snap-fit manner.

As such, when the antenna module 200 is coupled to the printed circuit board 100 in a snap-fit manner, it is not necessary to process a separate bolt hole or rivet hole in the printed circuit board 100 and the antenna module 200, making it easy to manufacture. And since there is no need to consider the space occupied by the bolt hole or rivet hole, the degree of freedom to arrange elements and feeding lines on the printed circuit board 100 and the degree of freedom to arrange an antenna slot 203 and a waveguide structure (not shown) on the antenna module 200 can be improved.

More specifically, the printed circuit board 100 includes a feeding part 110 that transmits a radio frequency (RF) signal.

For example, the feeding part 110 may be a feeding hole penetrating the top surface and lower surface of the printed circuit board 100 as shown in FIG. 1. At this time, the feeding hole is mounted on the bottom surface of the printed circuit board 100 and is connected to a feeding chip (not shown) that processes RF signals.

As another example, although the feeding part is not shown, the feeding part may be a feeding pad formed on the top surface of the printed circuit board. An integrated circuit (not shown) that processes RF signals may be mounted on the top surface of the printed circuit board 100, a feeding line (not shown) may be electrically connected to the integrated circuit, and a feeding pad may be electrically connected to the feeding line to transmit or receive RF signals.

The antenna module 200 is coupled to the printed circuit board 100. The antenna module 200 receives an RF signal from the feeding part 110 and emits the RF signal to the outside.

The antenna module 200 is coupled to the printed circuit board 100 such that the bottom surface thereof faces the top surface of the printed circuit board 100.

A plurality of antenna slots 203 for emitting RF signals are formed on the top surface of the antenna module 200. Inside the antenna module 200, a waveguide structure for moving the RF signal received from the feeding part 110 to the plurality of antenna slots 203 is provided.

According to an exemplary embodiment of the present disclosure, the antenna module 200 is coupled to the printed circuit board 100 in a snap-fit manner.

In an embodiment of the present disclosure, the antenna module 200 includes an antenna body 210 and a snap-fit coupling part 230.

The bottom surface of the antenna body 210 is disposed to face the top surface of the printed circuit board 100. A plurality of antenna slots 203 are formed on the top surface of the antenna body 210. Inside the antenna body 210, a waveguide structure (not shown) for moving the RF signal received from the feeding part 110 to the plurality of antenna slots 203 is provided.

In an embodiment of the present disclosure, the antenna body 210 may have a multi-layered structure.

For example, the antenna body 210 having a multi-layered structure may be integrally manufactured by an injection molding method.

As another example, the antenna body 210 having a multi-layered structure may be manufactured in a manner in which a plurality of layers are separately manufactured and coupled to each other. At this time, the plurality of layers may be coupled to each other in a snap-fit manner.

In an embodiment of the present disclosure, the bottom surface of the antenna body 210 and the top surface of the printed circuit board 100 facing each other may have the same shape and size.

For example, the bottom surface of the antenna body 210 and the top surface of the printed circuit board 100 facing each other may have a rectangular shape having the same size as in FIGS. 1 and 2.

Alternatively, although not shown, the bottom surface of the antenna body and the top surface of the printed circuit board facing each other may have different shapes and sizes. In this case, the shape and position of the snap-fit coupling part formed in the antenna body and coupled to the printed circuit board may be different from the snap-fit coupling part 230 shown in FIGS. 1 and 2.

In an embodiment of the present disclosure, the snap-fit coupling part 230 extends from the antenna body 210 toward the printed circuit board 100 and is coupled to the printed circuit board 100.

In an embodiment of the present disclosure, the snap-fit coupling part 230 may be provided in plurality. The plurality of snap-fit coupling parts 230 may be distributed and disposed in the antenna body 210 and coupled to the printed circuit board 100.

The snap-fit coupling part 230 may be manufactured integrally with the antenna body 210. For example, the snap-fit coupling part 230 may be integrally manufactured by injection molding. In this case, the antenna module 200 including the antenna body 210 and the snap-fit coupling part 230 may be manufactured simply and quickly by injection molding. At this time, the antenna module 200 including the snap-fit coupling part 230 and the antenna body 210 may be manufactured integrally by injection molding using a polymer such as plastic.

In an embodiment of the present disclosure, the snap-fit coupling part 230 may be disposed in an edge region of the antenna body 210. In this case, the degree of freedom in arranging the waveguide structure of the antenna body 210 may be improved compared to the case where the snap-fit coupling part 230 is disposed in the central region of the antenna body 210.

In an embodiment of the present disclosure, the snap-fit coupling part 230 may be formed to extend from the bottom surface of the antenna body 210 facing the printed circuit board 100 as shown in FIGS. 1 and 2. In this case, when the antenna module 200 is viewed from the top surface of the antenna body 210, the snap-fit coupling part 230 is not exposed to the outside and thus is not visible, or a portion exposed to the outside of the snap-fit coupling part 230 may be minimized. Accordingly, the size of the antenna module 200 may be relatively small.

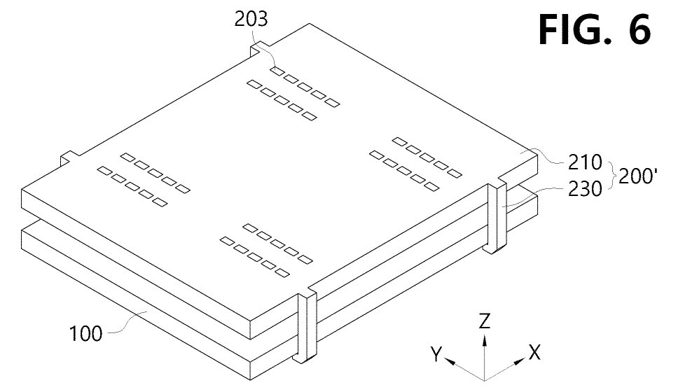

Alternatively, the snap-fit coupling part 230 may be formed to extend from the outermost side surface of the antenna body 210 as shown in FIG. 6. In other words, the snap-fit coupling part 230 may be formed to extend from an outer surface of an edge of the antenna body 210.

In this case, when the antenna module 200' is viewed from the top surface of the antenna body 210, the snap-fit coupling part 230 appears to be exposed to the outside. At this time, since the position of the snap-fit coupling part 230 can be easily recognized, it is easy to combine or separate the printed circuit board 100 and the antenna module 200'. For reference, FIG. 6 is a modified example of a formation position of a snap-fit coupling part shown in FIG. 1.

In an embodiment of the present disclosure, the snap-fit coupling part 230 includes an extension body 231 and a hook 233.

The extension body 231 extends from the antenna body 210. At this time, the extension body 231 may extend from the antenna body 210 toward the printed circuit board 100. At this time, the extension body 231 extends in a cantilever shape and is easily elastically deformed in a direction perpendicular to the extension direction.

The hook 233 is formed to protrude from the distal end of the extension body 231. At this time, the hook 233 may be formed to protrude in a direction perpendicular to the extension direction of the extension body 231.

Only when the antenna body 210 approaches the printed circuit board 100 and the hook 233 of the snap-fit coupling part 230 is caught on a part of the printed circuit board 100, the antenna body 210 may be coupled to the printed circuit board 100. In this case, the snap-fit coupling part 230 may have a strong supporting force or coupling force in a direction in which the antenna body 210 and the printed circuit board 100 are moved away from each other by the hook 233.

In an embodiment of the present disclosure, the snap-fit coupling part 230 may be inserted into the coupling hole 130 formed in the printed circuit board 100 as shown in FIGS. 1 to 5 and coupled to the printed circuit board 100.

At this time, the distal end of the snap-fit coupling part 230 is inserted into the coupling hole 130. The distal end of the snap-fit coupling part 230 is formed to be inserted into the coupling hole 130 and to be caught on a part of the printed circuit board 100.

At this time, a part of the extension body 231 constituting the distal end of the snap-fit coupling part 230 is placed within the coupling hole 130, and the hook 233 constituting the distal end of the snap-fit coupling part 230 is caught on the bottom surface of the printed circuit board 100.

In an embodiment of the present disclosure, the coupling hole 130 may be formed in an edge region of the printed circuit board 100. In this case, the degree of freedom in arranging the element and the feeding line with respect to the printed circuit board 100 may be improved compared to the case where the coupling hole 130 is formed in the central region of the printed circuit board 100.

In an embodiment of the present disclosure, the coupling hole 130 may have a shape that is open toward the outermost side surface of the printed circuit board 100 as shown in FIG. 2. In this case, compared to the case where the coupling hole 130 has a shape that is closed toward the outermost side surface, the coupling hole 130 may be located as far outside as possible within the edge region of the printed circuit board 100. In this case, the degree of freedom in arranging the element and the feeding line with respect to the printed circuit board 100 may be further improved.

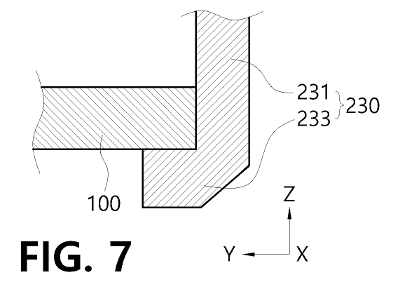

Alternatively, the distal end of the snap-fit coupling part 230 is formed to be caught on a part of the printed circuit board 100 while surrounding the outermost side surface of the printed circuit board 100 as shown in FIG. 7. For reference, FIG. 7 is a modified example of a coupling position of a distal end of the snap-fit coupling part shown in FIG. 6.

In this case, a part of the extension body 231 constituting the distal end of the snap-fit coupling part 230 is placed facing the outermost side surface of the printed circuit board 100, and the hook 233 constituting the snap-fit coupling part 230 is caught on the bottom surface of the printed circuit board 100.

In an embodiment of the present disclosure, a locking part to which the distal end of the snap-fit coupling part 230 is caught is formed on the printed circuit board 100. More specifically, a locking part to which the hook 233 constituting the distal end of the snap-fit coupling part 230 is caught is formed on the printed circuit board 100.

For example, as shown in FIGS. 1, 2, and 5, when the distal end of the snap-fit coupling part 230 is inserted into the coupling hole 130 formed in the printed circuit board 100 and coupled to the printed circuit board 100, the locking part may be the bottom surface of the printed circuit board 100 in contact with the inner surface of the coupling hole 130. In this case, the distal end of the snap-fit coupling part 230 is caught on the bottom surface of the printed circuit board 100 which is in contact with the inner surface of the coupling hole 130.

As another example, as shown in FIG. 7, when the distal end of the snap-fit coupling part 230 is coupled to the printed circuit board 100 while surrounding the outermost side surface of the printed circuit board 100, the locking part may be the bottom surface of the printed circuit board 100 in contact with the outermost side surface of the printed circuit board 100. In this case, the distal end of the snap-fit coupling part 230 is caught on the bottom surface of the printed circuit board 100 which is in contact with the outermost side surface of the printed circuit board 100.

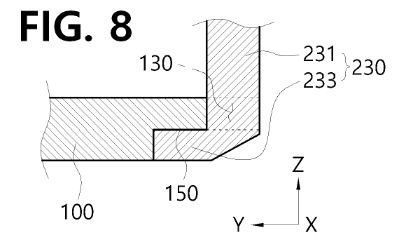

As yet another example, as shown in FIG. 8, when the distal end of the snap-fit coupling part 230 is inserted into the coupling hole 130 formed in the printed circuit board 100 and coupled to the printed circuit board 100, the locking part may be a stepped portion 150 formed in the coupling hole 130. For reference, FIG. 8 is a view illustrating a modified example of a position where the snap-fit coupling part shown in FIG. 7 is caught.

At this time, the hook 233 constituting the distal end of the snap-fit coupling part 230 inserted into the coupling hole 130 is caught in the stepped portion 150 formed in the coupling hole 130.

At this time, the lower end of the snap-fit coupling part 230 may be positioned on the same plane as the bottom surface of the printed circuit board 100. At this time, since the hook 233 of the snap-fit coupling part 230 does not protrude from the bottom surface of the printed circuit board 100, the antenna structure can be miniaturized, and interference with the outside can be minimized during the installation process of the antenna structure.

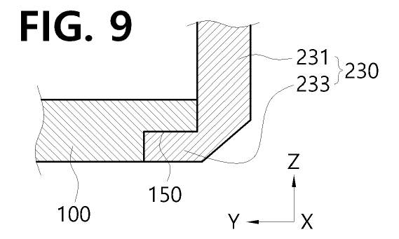

As yet another example, as shown in FIG. 9, when the distal end of the snap-fit coupling part 230 is coupled to the printed circuit board 100 while surrounding the outermost side surface of the printed circuit board 100, the locking part may be a stepped portion 150 formed on the outermost side surface of the printed circuit board 100. For reference, FIG. 9 is a view illustrating another modified example of a position where the snap-fit coupling part shown in FIG. 7 is caught.

At this time, the hook 233 constituting the distal end of the snap-fit coupling part 230 is caught in the stepped portion 150 formed on the outermost side surface of the printed circuit board 100.

At this time, the distal end of the snap-fit coupling part 230 may be positioned on the same plane as the bottom surface of the printed circuit board 100.

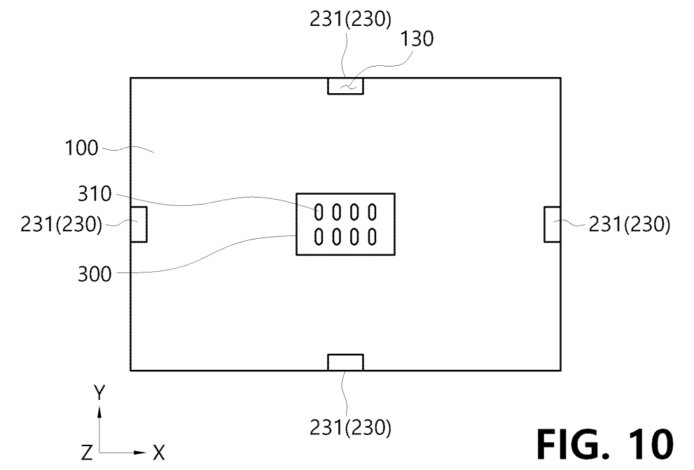

In an embodiment of the present disclosure, the snap-fit coupling part 230 is provided in plurality. The number and position of the plurality of snap-fit coupling parts 230 may be variously modified. In this regard, FIGS. 10 to 12 are views illustrating modified examples of the number and arrangement of snap-fit coupling parts according to an exemplary embodiment of the present disclosure, and are ones modified based on FIG. 4.

Referring to FIGS. 1 and 4, the number of the plurality of snap-fit coupling parts 230 may be four. For reference, in FIG. 1, two of the four snap-fit coupling parts 230 are not visible since they are covered by the antenna body 210.

At this time, two snap-fit coupling parts 230 may be disposed on each of the two sides facing each other of the four sides of the rectangular cross-section of the antenna body 210. The two snap-fit coupling parts 230 disposed on the same side may be disposed to be spaced apart from each other. At this time, the four snap-fit coupling parts 230 may be disposed to have a symmetrical structure around the antenna body 210.

The four snap-fit coupling parts 230 disposed as described above may be coupled to four points of the printed circuit board 100.

Referring to FIG. 10, the four snap-fit coupling parts 230 may be disposed to correspond one-to-one to the four sides of the rectangular cross-section of the antenna body (see 210 in FIG. 1), respectively. At this time, the four snap-fit coupling parts 230 may have a symmetrical structure around the antenna body (see 210 in FIG. 1).

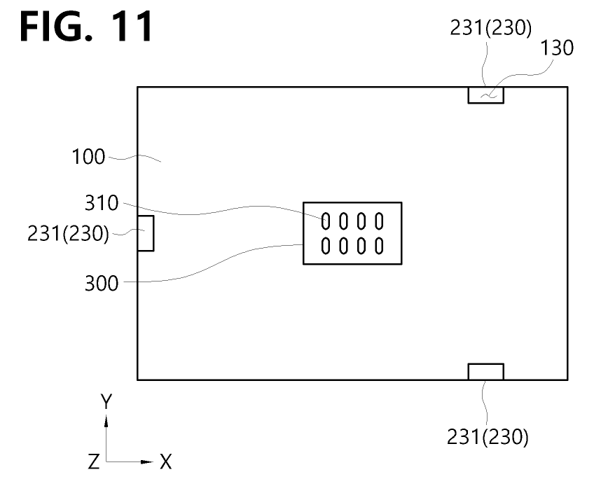

Referring to FIG. 11, the number of the plurality of snap-fit coupling parts 230 may be three.

At this time, the three snap-fit coupling parts 230 may be disposed to correspond one-to-one to the three sides of the four sides of the rectangular cross-section of the antenna body (see 210 in FIG. 1).

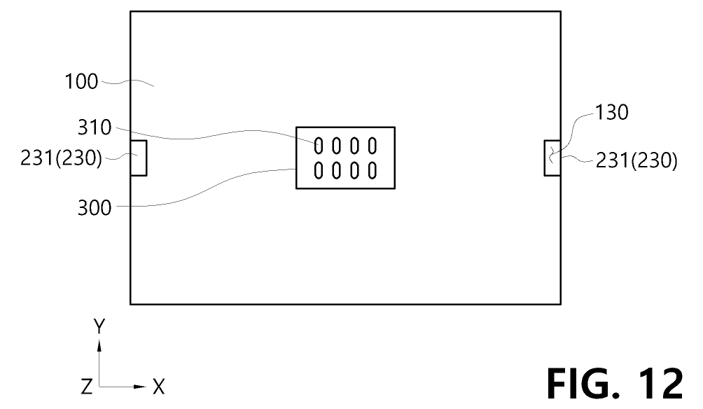

Referring to FIG. 12, the number of the plurality of snap-fit coupling parts 230 may be two.

At this time, the two snap-fit coupling parts 230 may be disposed to correspond one-to-one to the two sides facing each other of the four sides of the rectangular cross-section of the antenna body (see 210 in FIG. 1), respectively.

Meanwhile, the number and position of the plurality of snap-fit coupling parts may be variously modified in addition to the cases shown in FIGS. 4 and 10 to 12.

Referring to FIGS. 1 to 4, the antenna structure 10 according to an exemplary embodiment of the present disclosure may further include a spacer 300. The spacer 300 is interposed between the printed circuit board 100 and the antenna module 200 so that the printed circuit board 100 and the antenna module 200 are spaced apart at a predetermined interval.

In an embodiment of the present disclosure, the top surface of the printed circuit board 100 and the bottom surface of the antenna module 200 facing each other are supported on the bottom surface and the top surface of the spacer 300, respectively.

The distance between the top surface of the printed circuit board 100 and the bottom surface of the antenna module 200 by the spacer 300 may be determined by the thickness of the spacer 300, in other words, the height.

At this time, the spacer 300 has a thickness greater than or equal to the height of the highest element among elements (not shown) mounted on the top surface of the printed circuit board 100. In this case, the elements mounted on the top surface of the printed circuit board 100 and the antenna module 200 do not interfere with each other.

In an embodiment of the present disclosure, the printed circuit board 100 and the antenna body 210 are coupled in a state of being spaced apart by a predetermined interval by the spacer 300.

Alternatively, although not shown, the printed circuit board and the antenna body may be coupled in a form without gaps when viewed from the side. In this case, a separate spacer is not required, but a concave portion may be formed on the bottom surface of the antenna body to avoid interference with elements mounted on the printed circuit board.

In an embodiment of the present disclosure, the spacer 300 may be disposed at a position corresponding to the feeding part 110 formed on the top surface of the printed circuit board 100. For example, the feeding part 110 may be formed in the central region of the printed circuit board 100, and the spacer may be disposed in the central region of the printed circuit board 100 corresponding to the position of the feeding part 110.

The spacer 300 may be a column shape structure having a predetermined thickness. At this time, the spacer 300 may have a rectangular parallelepiped shape having a rectangular cross section as shown in FIGS. 2 and 4. Alternatively, although not shown, the spacer may have a column shape having a circular, elliptical, or polygonal cross section.

In an embodiment of the present disclosure, a waveguide 310 connecting the feeding part 110 and the antenna module 200 may be formed in the spacer 300. The number of waveguides 310 corresponds to the number of feeding parts 110.

The waveguide 310 formed in the spacer 300 is connected to a waveguide structure (not shown) formed inside the antenna module 200. The RF signal transmitted from the feeding part 110 is emitted outward from the antenna slot 203 formed on the top surface of the antenna module 200 through the waveguide 310 formed in the spacer 300 and the waveguide structure (not shown) formed inside the antenna module 200.

As such, the spacer 300 in which the waveguide 310 is formed is effective and economical because it serves to separate the printed circuit board 100 and the antenna module 200 at a predetermined interval and at the same time transmit the RF signal from the feeding part 110 to the antenna module 200.

In an embodiment of the present disclosure, the spacer 300 may be manufactured integrally with the antenna module 200. For example, the spacer 300 may be integrally manufactured with the antenna module 200 by injection molding.

Alternatively, the spacer 300 may be separately manufactured and attached to the top surface of the printed circuit board 100 or the bottom surface of the printed circuit board 100.

In an embodiment of the present disclosure, the spacer 300 in which the waveguide 310 is formed is disposed in the central region of the printed circuit board 100 as shown in FIG. 4 corresponding to the feeding part 110 formed in the central region of the top surface of the printed circuit board 100.

In this case, since the central region of the antenna structure 10 where the printed circuit board 100 and the antenna module 200 are combined is stably supported by the spacer, the external force acting on the antenna structure 10 may be distributed relatively uniformly through the plurality of snap-fit coupling parts 230, and the coupling force of the plurality of snap-fit coupling parts 230 may be kept relatively uniform.

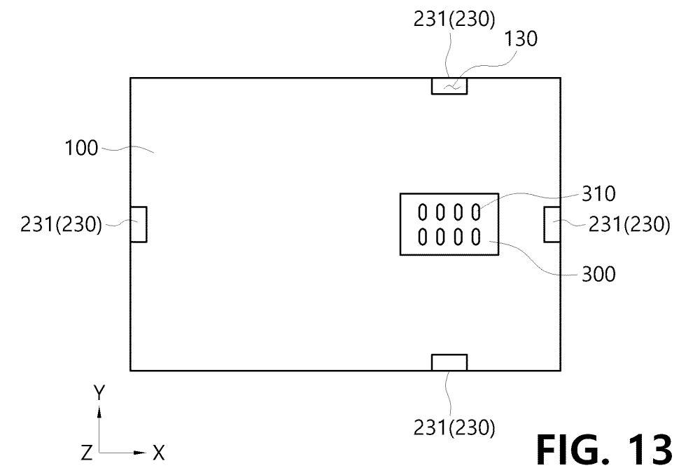

Meanwhile, FIG. 13 is a view illustrating a modified example of a position of a spacer according to an exemplary embodiment of the present disclosure, and is a view modified based on FIG. 4. Referring to FIG. 13, the spacer 300 in which the waveguide 310 is formed corresponding to the position of the feeding part (see 110 in FIG. 2) formed on the top surface of the printed circuit board 100 may be disposed to be biased in any one direction in the central region of the printed circuit board 100.

Since the antenna structure including the printed circuit board 100 and the antenna module (see 200 in FIG. 2) has a biased supporting force by the spacer 300, the external force acting on the antenna structure may be relatively unevenly distributed through the plurality of snap-fit coupling parts 230, and the coupling force of the plurality of snap-fit coupling parts 230 may be kept unevenly.

To solve this problem, the plurality of snap-fit coupling parts 230 are disposed so that external force is uniformly distributed.

To solve this problem, the spacer 300 in which the waveguide 310 is formed may be positioned to be biased in the right direction (+X direction) in the central region of the printed circuit board 100.

In this case, the antenna structure in which the printed circuit board 100 and the antenna module (see 200 in FIG. 2) are combined has a supporting force that is biased to the right direction from the central region of the printed circuit board 100 by the spacer 300.

If an external force (e.g., compressive force) acting on the antenna structure acts at a position adjacent to the position of the spacer 300, the spacer 300 sufficiently supports the external force, so the force transmitted to the plurality of snap-fit coupling part 230 is relatively small. At this time, the space between the printed circuit board 100 and the antenna module is not easily opened at a position far from the spacer 300.

However, if the compressive force acting on the antenna structure 10 acts far from the position of the spacer 300, the spacer 300 acts as a lever, making it easy to open between the printed circuit board 100 and the antenna module at a position adjacent to the spacer 300. In this case, a relatively large load is applied to the snap-fit coupling part 230 disposed adjacent to the spacer 300.

Therefore, if more snap-fit coupling parts 230 are disposed closer to the spacer 300 than are located far from the spacer 300, the external force acting on the antenna structure may be uniformly distributed by the plurality of snap-fit coupling parts 230.

According to the above configuration, the antenna structure according to an aspect of the present disclosure is easily manufactured because it is not necessary to process a separate bolt hole or rivet hole in the printed circuit board and the antenna module by combining the printed circuit board in an antenna module snap-fit method.

Since there is no need to consider the space occupied by the bolt hole or the rivet hole, the degree of freedom of arrangement of elements and feeding lines with respect to the printed circuit board, and the degree of freedom of arrangement of the antenna slot and waveguide structure with respect to the antenna module may be improved.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

1. An antenna structure, comprising:
a printed circuit board having a feeding part that transmits a radio frequency (RF) signal on one surface of the printed circuit board; and
an antenna module coupled to the printed circuit board so that one surface of the antenna module faces the one surface of the printed circuit board, and having the other surface on which a plurality of antenna slots for emitting the radio frequency signal received from the feeding part are formed,
wherein the antenna module is coupled to the printed circuit board in a snap-fit manner.

2. The antenna structure of claim 1,
wherein the antenna module comprises:
an antenna body having one surface facing one surface of the printed circuit board and the other surface on which the antenna slots are formed; and
a snap-fit coupling part extending from the antenna body toward the printed circuit board and coupled to the printed circuit board.

3. The antenna structure of claim 2, wherein the snap-fit coupling part is disposed in an edge region of the antenna body.

4. The antenna structure of claim 2, wherein the snap-fit coupling part is formed to extend from one surface of the antenna body facing the printed circuit board.

5. The antenna structure of claim 2, wherein the snap-fit coupling part is formed to extend from an outermost side surface of the antenna body.

6. The antenna structure of claim 2, wherein the antenna body and the snap-fit coupling part are integrally manufactured by injection molding.

7. The antenna structure of claim 2, wherein the snap-fit coupling part is provided in plurality.

8. The antenna structure of claim 2,
wherein a coupling hole penetrating between one surface and the other surface of the printed circuit board and into which a distal end of the snap-fit coupling part is inserted is formed in the printed circuit board, and
wherein the distal end of the snap-fit coupling part is formed to be inserted into the coupling hole and to be caught on a part of the printed circuit board.

9. The antenna structure of claim 8, wherein the coupling hole is formed in an edge region of the printed circuit board.

10. The antenna structure of claim 2, wherein a distal end of the snap-fit coupling part is formed to be caught on a part of the printed circuit board while surrounding an outermost side surface of the printed circuit board.

11. The antenna structure of claim 2, wherein a distal end of the snap-fit coupling part is formed to be caught on the other surface of the printed circuit board.

12. The antenna structure of claim 2,
wherein a coupling hole penetrating between one surface and the other surface of the printed circuit board and into which a distal end of the snap-fit coupling part is inserted is formed in the printed circuit board, and
wherein the distal end of the snap-fit coupling part is formed to be caught on a stepped portion formed inside the coupling hole.

13. The antenna structure of claim 2, wherein a distal end of the snap-fit coupling part is formed to be caught on a stepped portion formed on an outermost side surface of the printed circuit board.

14. The antenna structure of claim 2, wherein a distal end of the snap-fit coupling part is positioned on the same plane as the other surface of the printed circuit board.

15. The antenna structure of claim 2,
wherein the snap-fit coupling part comprises:
an extension body extending from the antenna body; and
a hook formed to protrude from a distal end of the extension body and caught on a part of the printed circuit board.

16. The antenna structure of claim 2, further comprising a spacer interposed between the printed circuit board and the antenna module so that the printed circuit board and the antenna module are spaced apart at a predetermined interval.

17. The antenna structure of claim 16,
wherein the spacer is disposed at a position corresponding to the feeding part, and
wherein a waveguide connecting the feeding part and the antenna module is formed in the spacer.

18. The antenna structure of claim 17, wherein the spacer is disposed at a central region of the printed circuit board.

19. The antenna structure of claim 18,
wherein the spacer is disposed to be biased in any one direction in the central region of the printed circuit board,
wherein the snap-fit coupling part is provided in plurality, and
wherein the plurality of snap-fit coupling parts are disposed such that external force acting on the antenna structure is uniformly distributed.

20. An antenna structure, comprising:
a printed circuit board; and
an antenna module coupled to the printed circuit board,
wherein the antenna module comprises:
an antenna body having one surface facing one surface of the printed circuit board and the other surface on which an antenna slot is formed; and
a plurality of snap-fit coupling parts extending from the antenna body toward the printed circuit board and coupled to the printed circuit board.
